(19) United States
(12) Patent Application Publication
(10) Pub. No.: US 2020/0156793 A1
(43) Pub. Date: May 21, 2020

(54) AIRCRAFT PERSONAL CONTENT SYSTEM

(71) Applicant: Innov8 Cabin Solutions, LLC, Sammamish, WA (US)

(72) Inventors: Steven R. Galipeau, Redmond, WA (US); Matthew W. Barclay, Woodinville, WA (US); Jason R. Danforth, Sammamish, WA (US)

(21) Appl. No.: 16/453,715

(22) Filed: Jun. 26, 2019

Related U.S. Application Data
(63) Continuation of application No. 15/795,710, filed on Oct. 27, 2017, now abandoned.
(60) Provisional application No. 62/415,273, filed on Oct. 31, 2016.

(51) Int. Cl. B64D 11/00; B64F 5/60; H04N 21/214; H04N 21/41; H04N 21/472; H04N 21/414; H04N 21/4402; H04N 21/2343; H04N 21/422; H04N 21/442

(52) U.S. Cl. CPC B64D 11/00152; B64F 5/60; H04N 21/2146; H04N 21/4126; H04N 21/47202; H04N 21/41422; B64D 47/08; H04N 21/234363; H04N 21/42202; H04N 21/44218; H04N 21/41407; B64D 2011/0053; Y02T 50/46; H04N 21/440263

(57) ABSTRACT

Systems and methods for connecting a personal entertainment device (PED) using the legacy technology provided in an aircraft, truck, or other vehicle. The system includes a digital content player that transmits audio and video signals in a first format, a video converter that converts the signals to a second format different from the first format, and a PED holder to which the PED is attached and secured. In addition, the PED holder includes one or more points of adjustment that enable a user to rotate and change the viewing angle for a PED attached to the PED holder. The PED holder may optionally include one or more electrical ports that enable the user to charge multiple devices at the same time. In addition, the electrical ports may be connected in a hub configuration that enables the devices connected to the multiple ports to communicate with one another.

### TECHNICAL FIELD

The present disclosure generally relates to personal entertainment devices, for example, to provide and manage personal entertainment devices on-board a private or business aircraft.

### BACKGROUND

### Description of the Related Art

Personal entertainment systems have long been incorporated into various types of aircraft, including personal and business aircraft, such as those that seat between 6-20 passengers. These legacy systems provide limited entertainment options for users who are increasingly able to access a broad range of entertainment regardless of their locations. In addition, the legacy systems may use older technologies and protocols that provide audio and/or video outputs of limited quality. Replacing the legacy systems on aircraft, though, may be technically difficult and prohibitively expensive. There exists, therefore, a need to upgrade and/or replace legacy audio/visual entertainment systems on aircraft with entertainment products and/or systems that can take advantage of the improved technology provided by modern personal entertainment devices.

### BRIEF SUMMARY

A system that provides multimedia entertainment and environmental controls to a user may be summarized as including a content manager that comprises a nontransitory storage medium that stores media content to be presented to the user, the content manager further comprising at least one communications port to transmit media content upon request by the user, wherein the media content is transmitted in a first format; a video converter that receives the media content transmitted by the content manager, the video converter comprising an converter that converts the received media content from the first format to a second format, wherein the video converter transmits the media content in the second format; and a personal entertainment device (PED) holder that includes one or more electrical ports to receive the media content transmitted by the video converter in the second format and that includes one or more registration features to attach a personal entertainment device (PED), wherein the PED holder includes one or more joints, each joint to provide an axis of rotation to adjust an angle at which the PED is displayed to the user. The content manager may transmit the media content in at least one format selected from the group consisting of an SDI format, a composite format, a VGA format, and an HDMI format. The video converter may at least one of upscale or downscale the received media content.

At least one of the one or more electrical ports of the PED holder may transmit data to a central computer to control one or more of a temperature, lighting, entertainment system, a toilet, or a window shade position or tint within an aircraft cabin. The PED may transmit data to a central computer to control one or more of a temperature, lighting, entertainment system, a toilet, or a window shade position or tint within an aircraft cabin.

At least one of the PED or the video converter may read state information associated with an aircraft. The state information may include at least one of flight information or water tank level information. The PED holder may include one or more grooves that engage with corresponding ridges on a sleeve that encloses a PED.

A personal entertainment device (PED) holder that may attach to a base, wherein the base may include one or more detents, may be summarized as including a vertical support that includes one or more contact ball bearings; and a release slide, wherein in an attached position, the release slide is positioned in a downward position such that the release slide asserts an inward force that engages the contact ball bearings with corresponding detents in the base. The vertical support may include one or more stringers that bear substantially all loads applied to the vertical support.

The vertical support may further include a hollow sleeve that covers the one or more stringers. In a released position, the release slide may be positioned in an upward position removing the inward force from the contact ball bearings to allow the contact ball bearings to disengage from the corresponding detents in the base.

A method for connecting to a personal electronic device (PED) running a first operating system may be summarized as including detecting that the PED has been attached to a PED holder; detecting the first operating system running on the PED; initiating a handshake protocol with the PED; pausing to allow the PED to reconnect in an accessory mode; and transmitting a data stream upon receiving a start stream command from the PED.

Detecting the first operating system may further include receiving vender identification data and product identification data from the PED. Detecting the first operating system may include detecting the operating system and determining compatibility of the PED.

The method may further include operating in a host mode when detecting that the PED has been connected to the PED holder. The start stream command may be transmitted automatically by the PED when the PED is attached to the PED holder.

A method for connecting to a personal electronic device (PED) running a first operating system may be summarized as including detecting that the PED has been attached to a PED holder; detecting the first operating system running on the PED; initiating a handshake protocol with the PED; receiving an identification from the PED of a port for transmitting data; and transmitting a data stream to the port upon receiving a start stream command from the PED. Detecting the first operating system may further include receiving vender identification data and product identification data from the PED.

The method may further include operating in a host mode when detecting that the PED has been connected to the PED holder. The start stream command may be transmitted automatically by the PED when the PED is attached to the PED holder.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a block diagram of a personal entertainment system, according to one illustrated implementation.

FIG. 2 is a block diagram showing the various components of a personal entertainment system, according to one illustrated implementation.

FIG. 3 shows a method for providing audio/video data to a personal entertainment device that uses an Android® operating system, according to one illustrated implementation.

FIG. 4 shows a method for providing audio/video data to a personal entertainment device that uses an iOS® operating system, according to one illustrated implementation.

FIG. 5 is an isometric view of a personal entertainment device holder, according to one illustrated implementation.

FIG. 6A is a sectional elevational view of a vertical support of a personal entertainment device holder that is connected to a base incorporated into an airplane surface, according to an illustrated implementation.

FIG. 6B is a sectional elevational view of the vertical support from FIG. 6A that is now disconnected from the base, according to an illustrated implementation.

FIG. 7 is an isometric view of the interior of a vertical support of a personal entertainment device holder, according to an illustrated implementation.

FIG. 8 is an isometric view of a portion of a personal entertainment device holder in which a first joint is attached to both a vertical support and a long horizontal support, according to one illustrated implementation.

FIG. 9 is an isometric view of an interior portion of a long horizontal support in a personal entertainment device holder, according to one illustrated implementation.

FIG. 10 is an isometric view of a portion of a personal entertainment device holder that shows one end of a long horizontal support, a second joint, a short horizontal support, and a third joint, according to one illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

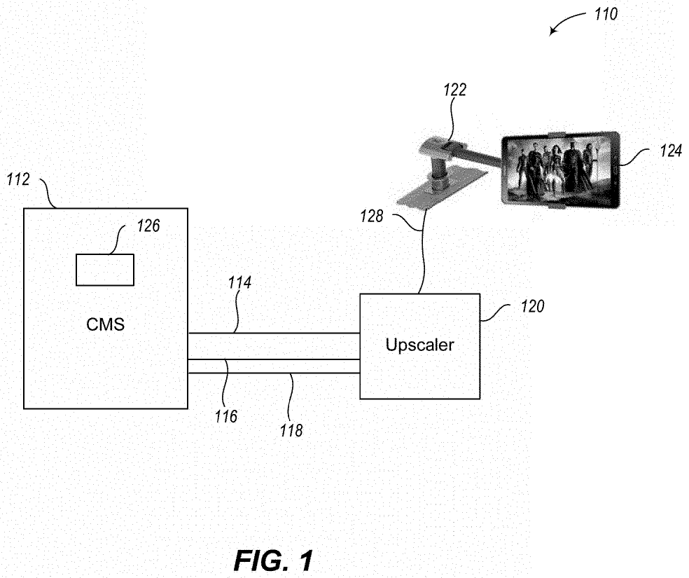

FIG. 1 is a block diagram of a personal entertainment system 110, according to one illustrated implementation. The personal entertainment system 110 includes a content management system (“CMS”) 112, video connection 114, a right audio connection 116, a left audio connection 118, a video converter 120, a personal entertainment device (“PED”) holder 122, and a PED 124. The CMS 112 includes a digital media player 126 that stores digital content (e.g., videos, music, audiobooks, etc.) for playback to customers or users via PED 124 or some other output device, such as headphones, virtual reality headsets, or the like. In some implementations, the digital content may be a moving map that shows the real-time location of the device on one or more maps. In some implementations, the digital media player 126 stores media content on any high-speed random access memory or non-volatile memory that is internal to the digital media player 126, such as one or more magnetic disk storage devices, one or more optical storage devices, or flash memory. The digital media player 126 may also have one or more input terminals that can accept external, removable media storage devices, such as a secure digital (SD) card, a compact flash (CF) card, a universal serial bus (USB) memory stick, a flash drive, or the like, that store media content for playback to a user through the personal entertainment system 110. In some implementations, the CMS 112 may also provide video feeds from one or more video cameras mounted, for example, throughout a business or private aircraft. The video feeds from these aircraft may be connected to the digital media player 126 for distribution to one or more PEDs 124.

The digital media player 126 outputs one or more video and audio signals. The video signals may be in any number of formats. In existing private and business aircraft, for example, analog or digital video signals may be output in composite or SDI formats that provide standard definition video with 480i resolution. For composite video signals, the digital media player 126 outputs a video signal on the video connection 114, and the digital media player 126 outputs a right audio signal on the right audio connection 116 and a left audio signal on the left audio connection 118. The right audio connection 116 and the left audio connection 118 carry analog audio signals, such as those used to carry mono or stereo audio recordings. In some implementations, such as those in which the media content is transmitted in the SDI format, the digital media player 126 may output the video and audio signals on a single wire or cable, such as a coaxial cable that has a BNC connector or some other type of coaxial cable connector. The digital media player 126 may output a video signal in other formats, such as Video Graphics Array (VGA) formatted signals, High Definition Multimedia Interface (HDMI) compatible signals, or video signals formatted for a 4k video displays.

The audio and video signals carried by the video connection 114 and the audio connections 116 and 118 are received by the video converter 120, which modifies the audio and video signals to be transmitted to the PED 124. The video converter 120 may include one or more logic processing units, such as one or more central processing units (CPUs), microprocessors, digital signal processors (DSPs), application-specific integrated circuits (ASICs), field programmable gate arrays (FPGAs), etc. The video converter 120 may also include one or more solid state memories, for instance Flash memory or solid state drive (SSD), which provide nonvolatile storage of computer-readable instructions, data structures, program modules and other data for the video converter 120. Although not depicted, the video converter 120 can employ other nontransitory computer- or processor-readable media, for example a hard disk drive, an optical disk drive, or memory card media drive.

In some implementations, the video converter 120 upconverts the 480i formatted standard-definition analog video signal into a high definition digital video signal. In at least some implementations, the upconversion may be performed or handled by the PED 124. For example, the video converter 120 may convert the analog video signal received via video connection 114 into a digitally formatted video signal that uses the H.264 encoding standard to provide video with 1080p resolution. The video converter 120 may also convert the audio signals from the right audio connection 116 and the left audio connection 118 into a digital format that can be combined with the digitized video signal. In such situations, the video converter 120 may use, for example, the MPEG-4 standard for storing and transmitting the combined, digitized audio and video data. The video converter 120 outputs the digitized audio/video signal to the PED 124 using one or more output ports. In at least some implementations, the video converter 120 may output copies of the audio and/or video signals to multiple heterogeneous PEDs. In addition, in some implementations, the video converter 120 provides power for the PED 124 when the PED 124 is secured by the PED holder 122, as discussed below.

The PED 124 receives the audio/video signal transmitted by the video converter 120. In some implementations, the video converter 120 or the CMS 112 may wirelessly transmit the audio/video signal to the PED 124 using a wireless communications protocols, such as protocols for wireless local area networks (e.g., WIFI®, IEEE 802.11, WiMAX, IEEE 802.116, VoIP, and the like) or protocols for wireless peer-to-peer communications (e.g., Bluetooth®, Bluetooth® Low Energy, and the like). Alternatively, the audio/video signal may be transmitted from the video converter 120 to the PED 124 using a wired connection 128. The wired connection 128 may use parallel cables or serial cables capable of high speed communications using, for example, one or more of FireWire®, Universal Serial Bus® (USB), Thunderbolt®, or Gigabyte Ethernet®. The video converter 120 and the PED 124 can optionally use various other communication protocols instead of or in addition to those listed above to exchange communications and data over a wireless or a wired connection. For example, the video converter 120 and the PED 124 may use the transmission control protocol/internet protocol (TCP/IP), the user datagram protocol/internet protocol (UDP/IP), and the like to communicate with each other.

The PED 124 is a consumer electronic device that renders audio and video data. In some implementations, the PED 124 runs one or more mobile operating systems, such as the iOS® operating system provided by Apple Inc., the Android® operating system provided by Google Inc., the Windows® Phone operating system provided by Microsoft Corp., or other similar mobile operating systems. In addition, the PED 124 may include one or more apps that enable the PED 124 to communicate with and receive video, audio, and other media from the video converter 120. The PED 124 provides one or more outputs to a user via one or more output devices. For example, the PED 124 may provide the video output using a video screen, or using one or more video interfaces that connect to other local devices, such as, for example, a virtual reality head mounted display, an augmented reality headset, or the like, that are external to the PED 124. The PED 124 may provide the audio output using speakers that are incorporated into the PED 124, or using one or more audio interfaces that connect to other local devices, such as external speakers, a headphone, or the like, that are external to the PED 124. The video and/or audio interfaces that connect the PED 124 to external devices may include one or more wired interfaces, or one or more wireless interfaces, such as those used to provide wireless local area networks (e.g., WIFI®, IEEE 802.11, WiMAX, IEEE 802.116, VoIP, and the like) or to provide wireless peer-to-peer communications (e.g., Bluetooth®, Bluetooth® Low Energy, and the like).

In some implementations, the PED 124 can provide an interactive display for a user. A user can enter commands and information via a pointer, such as a finger or stylus used to provide input to a touch screen, or via a computer mouse or trackball which controls a cursor. Other input devices can include a keyboard, microphone, joystick, game pad, tablet, scanner, biometric scanning device, etc. In such an implementation, the PED 124 enables a user to access the Internet or play interactive games. An interactive display for PED 124 can also be used to provide environmental controls to a user. For example, when the PED 124 is in an airplane, the PED 124 can be used to control the user's lighting, to operate the user's window controls/shades, or to provide a signal to a flight attendant for services.

The PED holder 122 holds the PED 124 for viewing and use by the user. In addition, the PED holder 122 can provide one or more wired and wireless connections to receive the audio/video (A/V) signals being transmitted from the video converter 120, and to provide the received A/V signals to the PED 124. The PED holder 122 may include a connection that provides power to the PED 124. In some implementations, the PED holder 122 provides the A/V signal and the power to the PED 124 using the same connection, such as, for example, when the PED holder 122 uses a USB connection to provide A/V signals to the PED 124. In some implementations, the PED holder 122 can use one or more standardized interfaces, such as connections for FireWire®, USB®, Thunderbolt®, or Gigabyte Ethernet®, to connect to the PED 124. By using standardized interfaces, the PED 124 can be quickly and efficiently swapped out, such as, for example, when a PED 124 becomes broken or disabled, or to be updated as newer equipment becomes available.

In some implementations, as discussed below, the PED holder 122 can be changed from a compact, stored state to a viewing state. In the compact, stored state, the PED holder 122 can be folded at one or more points to minimize the amount of space that the PED holder 122 occupies. The PED holder 122 may be folded into the compact state either with or without a PED 124 attached. The PED holder 122 may be extended into a viewing state that enables a user to interact with and view media content on the PED 124. The PED holder 124 may also provide one or more points of adjustment that enable a user to adjust the viewing angle of the PED 124. At least some of the points of adjustment can be used to change the PED holder 124 between the compact state and the viewing state.

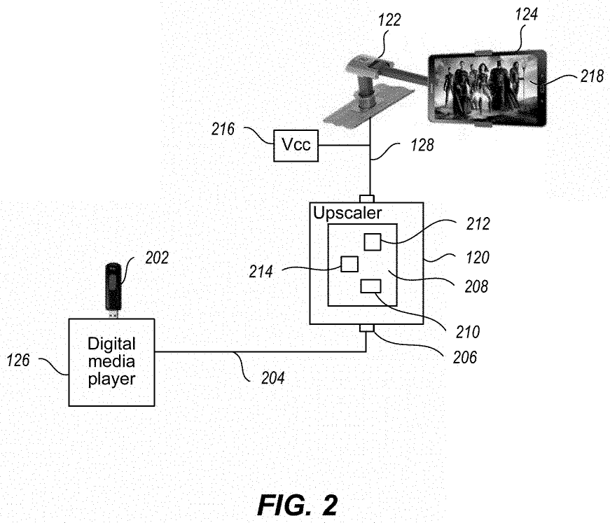

FIG. 2 is a block diagram showing the various components of a personal entertainment system 110, according to one illustrated implementation. The personal entertainment system 110 includes a digital media player 126, a video converter 120, a PED holder 122, and a PED 124. The digital media player 126 can play media content that is stored on one or more internal memories, or it can play media content that is stored in one or more external memory devices, such as external memory 202, as discussed above. The digital media player 126 is electrically coupled to the video converter 120 through a coaxial cable 204. Video formats other than SDI may be used, such as Composite or HDMI, for example. In such instances, appropriate wiring connections are used. In at least one implementation, the digital media player 126 outputs onto coaxial cable 204 an SDI formatted A/V signal. The A/V signal may have a resolution of 480i, or a resolution of up to 4k or more, for example. Non-limiting examples include SD-SDI, HD-SDI and 3G-SDI, for example. The SDI formatted signal includes at least a video signal and a left and a right audio signal.

The video converter 120 receives the SDI formatted A/V signal via coaxial connection 206. The video converter 120 includes one or more processors that convert the standard definition, SDI formatted A/V signal received from the digital media player 126 into a high definition digital output signal that can be transmitted to the PED 124. As noted above, in some implementations the upscaling may be performed by the PED 124. Other conversions are contemplated. For example, the video converter 120 may convert a high definition signal into h264 with or without upscale. Additionally, the video converter 120 could downscale the signal if the PED 124 is unable to handle a higher definition video. For example, a 1080p SDI input signal may be downconverted to a 720p signal to work with a legacy PED which cannot receive 1080p signals. In some implementations, the video converter 120 may process and convert the A/V signals using at least one FPGA-based integrated circuit that may optionally operate as a system on chip (SoC) 208 by including one or more components that are designed and built to quickly and efficiently perform specific functions. For example, the video converter 120 may include a programmable SoC 208 that has a first core 210 for receiving SDI formatted A/V data transmitted by the digital media player 126, and a second core 212 for encoding the received video data into H.264 formatted compressed video. In addition, the video converter 120 may include one or more audio codecs, such as the Advanced Audio Coding (AAC) codec or the Apple Lossless Audio Codec (ALAC), that it uses to compress and encode the received audio signals. The video converter 120 may combine the encoded video content and the encoded audio content into a single container format, such as MPEG-4, QuickTime, Flash, or similar format, that is used to store and transport digital multimedia content.

The SoC 208 may also include one or more CPUs 214. The CPU 214 may include one or more of a microprocessor, digital signal processor (DSPs), application-specific integrated circuit (ASIC), field programmable gate array (FPGA), etc. The video converter 120 may use the CPU 212 to establish a connection and communicate with the PED 124 via USB connection 128. In some implementations, the procedures and protocols used to communicate with the PED 124 will depend on the operating system that is running on the PED 124. Thus, once the video converter 120 has initialized the FPGA component of the SoC 208, the video converter 120 and its components wait until a PED 124 is connected via the PED holder 122. When the PED 124 is connected to the PED holder 122, the PED 124 may transmit vendor ID and/or product ID codes that enable the CPU 214 within SoC 208 to determine the type of device and the type of operating system that is used on the PED 124. If the vendor ID and/or product ID are indeterminate, the video converter 120 may use an algorithm to probe the PED 124 to determine if the PED is compatible with the video converter. The video converter 120 will attempt to connect to the PED 124 once the video converter 120 determines the type of operating system that is used on the PED 124. For example, for an iOS® device, the SoC 208 may use the USB Multiplex protocol to establish a connection and communicate with the iOS® device through a TCP port. As another example, for iOS®, an Apple® authentication co-processor may be used to provide access to the iDevice Accessory Protocol 2 (iAP2) (e.g., through the Made For iDevice (MFi) program). Using the authentication co-processor and iAP2, the video converter can request an App is launched to begin media playback. Alternatively, for an Android® device, the SoC 208 may use the Android® Open Accessory Protocol to establish a connection and communicate with the Android® device using the bulk data endpoint option. For either an iOS® device or an Android® device, once a connection is established between the video converter 120 and the PED 124, the video converter 120 may wait to receive a start-of-stream command from the PED 124 before streaming the A/V multimedia content to the PED 124. Alternatively, an app may be loaded on the PED 124 that causes the PED 124 to transmit a start-of-stream command automatically when the PED 124 is inserted into the PED holder 122. In some implementations, the PED holder 122 may have a near field communication (NFC) tag that communicates with an app loaded onto the PED 124 when the PED 124 is close to or in contact with the PED holder 122.

Prior to the start-of-stream command, in at least some implementations a handshake protocol is used that transfers configuration data to and from the PED 124. This configuration may include branding, splash screen images, Aircraft specific configuration and APIs—such as APIs for accessing ARINC 429 data, controlling aircraft interfaces, or reading aircraft environment data. The handshake may include cryptographic authentication of the PED 124 and the video converter 120 to ensure the PED application is communicating with an authentic video converter device. This may also include establishment of a session key for encrypting communications between the video converter 120 and the application of the PED 120.

In at least some implementations, iAP2 may be used to automate pairing the PED 124 with Bluetooth® headphones and joining the PED to a secure aircraft WiFi network.

In some implementations, the video converter 120 provides power to the PED 124. When the video converter 120 and the PED 124 are connected using USB connection 128, the video converter 120 may provide power to PED 124 using one or more power delivery protocols for USB connections. For example, when the SoC 208 acts as the USB host, the SoC 208 can provide power to the PED 124, which acts as a USB peripheral device. As another example, the USB Power Delivery, Version 2, protocol allows for bi-directional power delivery between devices connected using a USB connection. Accordingly, in this implementation, the video converter 120 can provide power regardless of whether it functions as a USB host or a USB peripheral device. In such an implementation, the PED 124 and the PED holder 122 may both have a USB Type C port. As another example, the PED 124 may support USB On-the-Go (OTG) and can be charged even when serving as a host in a USB connection. In such implementations, a resistor (e.g., a 100kΩ resistor) may be placed between pin 4 and pin 5 on the USB connector that attaches to the PED 124 to enable the OTG charging feature. In addition, an external power source 216 may need to be connected to the V_{CC} and ground lines for the USB connection 128 to provide power to the PED 124. Optionally, the external power source 216 may be incorporated into the video converter 120. The video converter 120 may provide one or more of these features for providing power to the PED 124 even when the PED 124 functions as the USB host device.

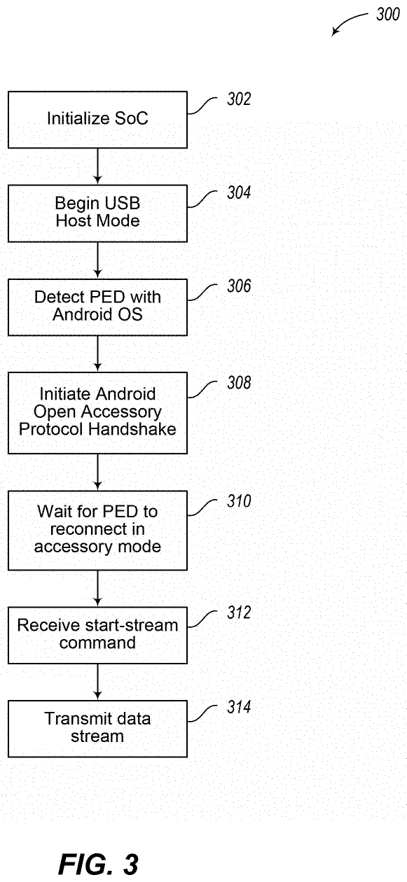

FIG. 3 shows a method 300 for a video converter 120 to provide video to a PED 124 that uses an Android® operating system.

At 302, the video converter 120 initializes the SoC 208. In some implementations, for example, if the CPU 214 is implemented using an FPGA, the video converter 120 may need to initialize the FPGA with the appropriate programming upon start up.

At 304, the video converter 120 begins to operate in USB host mode. As part of USB host mode, the video converter 120 will assume control over any communications resulting when other devices attempt to connect to the video converter 120 through a USB port.

At 306, the video converter 120 detects that a PED 124 using the Android® operating system has been connected a USB port provided by the PED holder 122. The video converter 120 makes this determination based upon vendor ID and product ID information that is transmitted by the PED 124 when it is connected to a USB connector on the PED holder 122. The USB port on the PED holder 122 communicates with the video converter 120 via USB wire 128.

At 308, upon determining that the PED 124 functions using the Android® operating system, the video converter 120 sends an Android® Open Accessory Protocol handshake to the PED 124. The video converter 120 functions as a standard USB bulk data endpoint during this process.

At 310, the video converter 120 waits while the PED 124 performs a soft disconnect with the video converter 120, and then reconnects in accessory mode. By connecting in accessory mode, the PED 124 will advantageously be able to obtain power from the video converter 120 even when the PED 124 supports only older, legacy USB standards. In instances where the PED 124 is an Android® device, the PED receives power the entire time the PED is connected. In such instances, accessory mode just enables a bulk USB endpoint that can be used for high bandwidth data. The accessory protocol allows the video converter 120 to request a specific app is launched on the PED 124. For example, the video converter 120 may request a media player app developed specifically for this system is launched automatically.

At 312, the video converter 120 receives a start-stream-command from the PED 124. The start-stream-command may result from user interaction with the PED 124, such as, for example, a user initiating a request for digital or multimedia content. In some implementations, one or more apps loaded onto the PED 124 may cause the PED 124 to automatically send a start-stream-command upon being connected to the PED holder 122. As discussed above for iOS®, a handshake protocol may be implemented before this, or in parallel to the video stream, that transfers configuration, images, splash screens, etc., between the video converter 120 and PED App. The PED App may also include maintenance functions, normally hidden from the user, to transfer log data, download video converter software updates from the Internet, and transfer video converter software updates to the video converter itself. The PED App may also download configuration loads specific to the aircraft the video converter 120 is installed on or the specific customer.

At 314, the video converter 120 begins encoding audio and video into a multimedia stream using one or more encoding protocols, such as MPEG-4. The video converter 120 streams the MPEG-4 data to the PED 124 over the USB connection 128 using the USB bulk endpoint feature. The video converter 120 may customize audio/video parameters, codec, bitrates, etc., for the specific PED to which the video converter is connected.

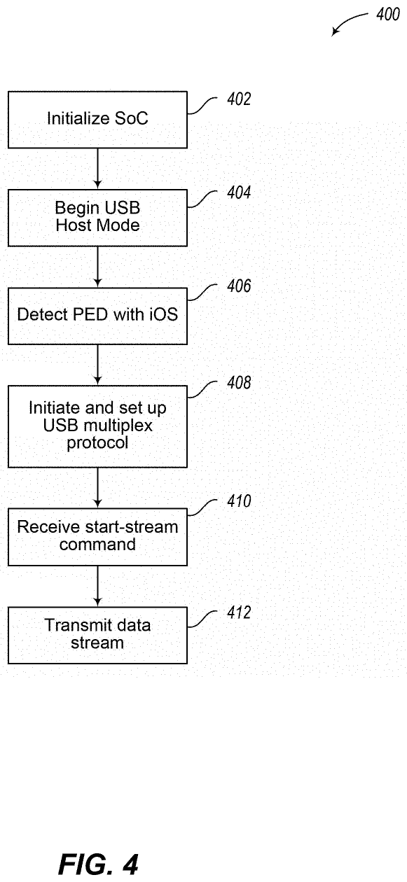

FIG. 4 shows a method 400 for a video converter 120 to provide video to a PED 124 that uses an iOS® operating system, according to one illustrated implementation.

At 402, the video converter 120 initializes the SoC 208. In some implementations, for example, if the CPU 214 is implemented using an FPGA, the video converter 120 may need to initialize the FPGA with the appropriate programming upon start up.

At 404, the video converter 120 begins to operate in USB host mode. As part of USB host mode, the video converter 120 will assume control over any communications resulting when other devices attempt to connect to the video converter 120 through a USB port.

At 406, the video converter 120 detects that a PED 124 using the iOS® operating system has been connected a USB port provided by the PED holder 122. The video converter 120 makes this determination based upon vendor ID and product ID information that is transmitted by the PED 124 when it is connected to a USB connector on the PED holder 122. The USB port on the PED holder 122 communicates with the video converter 120 via USB wire 128.

At 408, the video converter 120 sets up the USB Multiplex Protocol by initiating a handshake sequence with the PED 124. Upon completion of the handshake sequence, the video converter 120 connects to a TCP port on the PED 124 using the USB Multiplex Protocol. As noted above, in addition to the USBMUX interface, the video converter 120 may communicate using the iPod Accessory Protocol (iAP2) using an authentication co-processor chip provided by Apple®. Such allows to automate launching of a custom Media Player App written specifically to interface with the video converter 120.

At 410, the video converter 120 receives a start-stream-command from the PED 124. As discussed above, in at least some implementations there is an additional handshake between the Media Player App and the video converter 120 including crypto authentication to ensure authenticity, a session key for encrypting data between the devices, and transfer of configuration and software loads, maintenance logs, etc. The start-stream-command may result from user interaction with the PED 124, such as, for example, a user initiating a request for digital or multimedia content. In some implementations, one or more apps loaded onto the PED 124 may cause the PED 124 to automatically send a start-stream-command upon being connected to the PED holder 122.

At 412, the video converter 120 begins encoding audio and video into a multimedia stream using one or more encoding protocols, such as MPEG-4. The video converter 120 streams the MPEG-4 data to the PED 124 over the USB connection 128 using a TCP over USB socket.

The PED 124 may include one or more programs or apps that enable a user to access media content stored on the CMS 112. The apps may provide one or more menus to the user to access various types of media content, such as, for example, movies, TV shows, music, etc., stored on the digital media player 126 or some other storage device 202. The apps on the PED 124 may further provide a menu for the user to access one or more interactive games stored on the digital media player 126 or another storage device 202. In addition, the apps on the PED 124 may be used to provide flight related information to the user, such as, for example, a display that shows altitude, speed, time to destination, etc., or a moving map that shows the device's location relative to locations on one or more maps displayed on a screen 218 for the PED 124. Additionally or alternatively, flight information may be provided as an overlay on top of media played from the CMS 112 or the video converter 120. When the PED 124 is used to view stored media content or flight information, the app may go into a “monitor mode” that maximizes the display of the media content or flight information on the screen 218.

In some embodiments, the PED 124 may include apps that enable a user to control the surrounding cabin environment, for example, when the PED 124 is being used on a private, business, or commercial aircraft. For example, an app on the PED 124 may enable a user to control the surrounding temperature, lighting, or window shade position for electro-mechanical shades or window shade tint for electronic window shades. Control over each item may be provided using an icon or text that is selected by a user. In some implementations, the PED 124 generates a signal in response to a user selection of an icon or text associated with a device, such as lights or shades. The PED 124 then transmits this signal to a central processor that is connected to and communicates with each PED 124 on an aircraft. In response, the central processor may then transmit a signal to an appropriate controller card that controls the device selected by the user. The controller card will operate a relay, potentiometer, or other mechanism to carry out the user's request.

In at least some implementations, a maintenance app may be implemented as an additional app or a hidden screen within the main app. Maintenance functions may include: downloading video converter software updates and transmitting the software parts to the video converter for dataload, downloading video converter configuration parts and transmitting to video converter, uploading logs and usage data from video converter to the customer's servers or service provider servers.

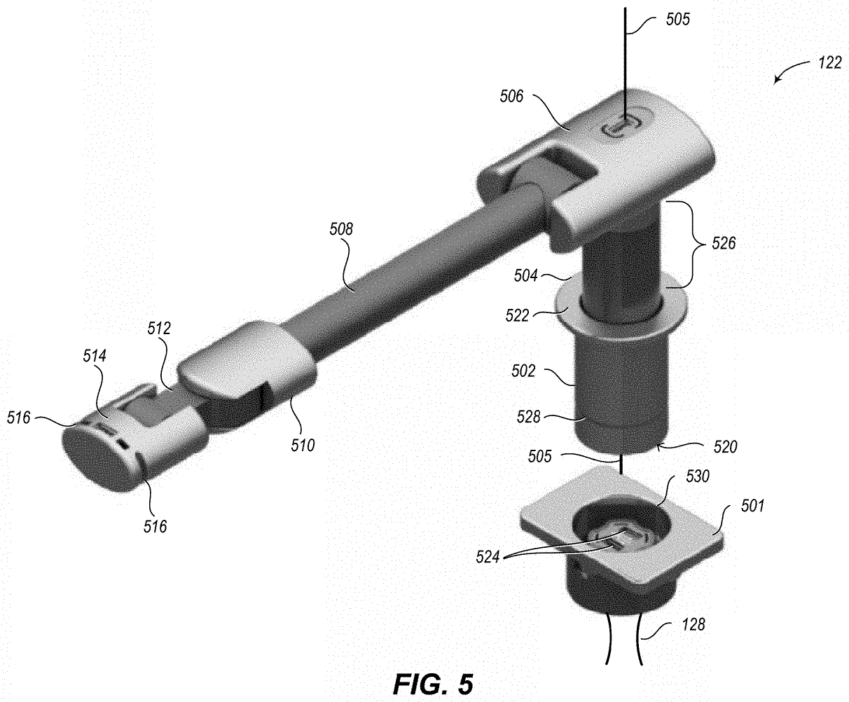

FIG. 5 is an isometric view of a PED holder 122 and a corresponding base 501, according to one illustrated implementation. The PED holder 122 includes a release slide 502, vertical support 504, a first joint 506, a first, long horizontal support 508, a second joint 510, a second, short horizontal support 512, a third joint 514, and one or more latches or other components 516 to secure the PED 124 to the PED holder 122. The PED holder 122 is secured to a surface, such as a surface in an airplane cabin, by engaging the PED holder 122 with the base 501, as discussed below. The surface may be, for example, an arm of a chair, a table, or a bulkhead or sidewall of an airplane. In such implementations, the base 501 is attached to the surface using one or more registration features, such as screws and nuts, or bolts. The PED holder 122 is then attached to the base 501 using a releasable registration feature that, as discussed below, allows for the PED holder 122 to be quickly and efficiently removed from the base 501. Alternatively, the base 501 may be installed on a surface located in some other type of vehicle or environment, such as, for example, the interior of a truck cabin or a ship cabin, or like environments with limited physical space.

The release slide 502 has a substantially cylindrical shape with a bottom end 520 that is inserted into the base 501 and a top end 522 that extends up from the surface and outward away from a central axis defined by the cylindrical shape of the release slide 502. The central axis for the release slide 502 runs from the bottom end 520 towards a top end 522 of the release slide 502. In some implementations, the release slide 502 may have a different shape, such as oval or square. The base 501 is sized and shaped to receive at least some of the release slide 502. In such implementations, the outward projection at the top end 522 of the release slide 502 may be of sufficient length to extend past and cover the edges of an opening 530 in the base 501 into which the release slide 502 is inserted.

The release slide 502 has an interior opening that is sized and shaped to accept the vertical support 504. The vertical support 504 is substantially cylindrical with a central axis 505 that runs within the center of the vertical support 504. The vertical support 504 has a radius that is slightly less than the radius of the interior opening of the release slide 502. An exposed portion 526 of the vertical support 504 from just below the first joint 506 to just above the release slide 502 is between five inches and eight inches in length.

In some implementations, a bottom end 528 of the vertical support 504 includes one or more electrical connectors that connect the video converter 120 and the PED 124. The connectors located in the bottom end 528 of the vertical support 504 may be, for example, one or more USB type ports that receive a USB connector from the USB connection 128. As shown in FIG. 5, the bottom end 528 of the vertical support 504 may be covered by the release slide 502. The base 501 has one or more electrical connectors or ports 524, such as USB ports, that correspond to the connectors at the bottom end 528 of the vertical support 504. Further, in some implementations, the electrical connectors 524 on the base 501 are attached to the wired connection 128 that connects to the video converter 120. Accordingly, the electrical connectors 524 from the base 501 may be aligned and engaged with the corresponding electrical connectors on the vertical support 504, thus creating an electrical connection between the base 501 and the vertical support 504 that allows electrical signals to be transmitted between the video converter 120 and the PED holder 122. The electrical signals may carry data, thus allowing, for example, digital content to be transmitted from the video converter 120 to the PED holder 122. Optionally, the electrical signals may be used to provide power to devices attached to the PED holder 122.

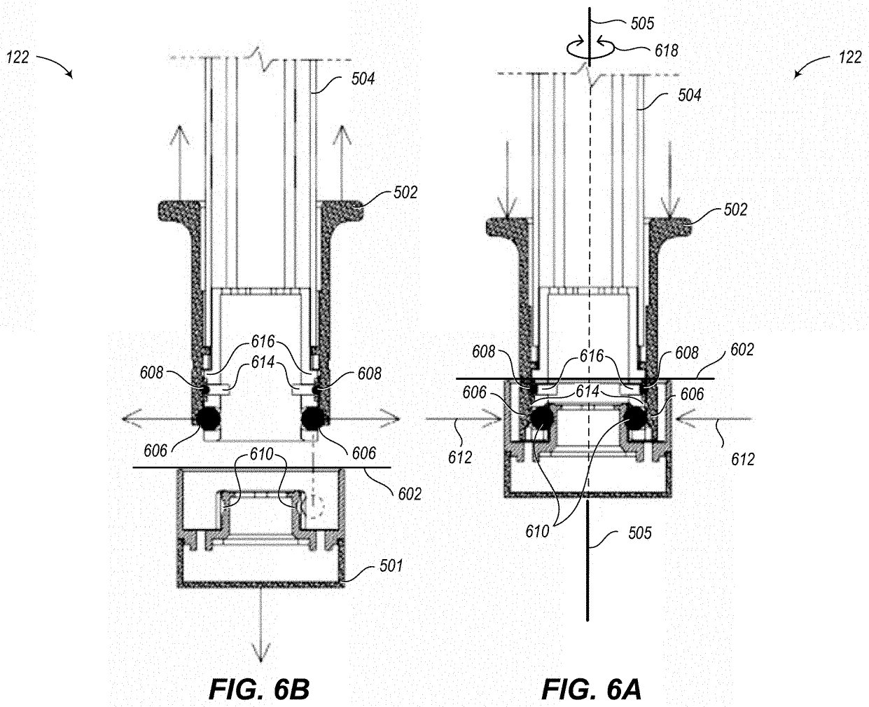

FIG. 6A is a sectional elevational view of a vertical support 504 of a personal entertainment device holder 122 that is connected to a base 501 incorporated into an airplane surface 602, according to an illustrated implementation. FIG. 6B is a sectional elevational view of the vertical support 504 from FIG. 6A that is now disconnected from the base 501, according to an illustrated implementation. As shown in FIG. 6A, the vertical support 504 includes a set of contact ball bearings 606 and a set of release ball bearings 608 located above the set of contact ball bearings 606. The base 501 has a set of detents 610 on an interior wall that correspond to the set of contact ball bearings 606. When the vertical support 504 is engaged with and connected to the base 501, at least a portion of each contact ball bearing is engaged with a corresponding detent 610 within the base 501. The release slide 502 is in a down position, which provides an inward force 612 on each contact ball bearing 606 to keep the contact ball bearings 606 engaged with the corresponding detents 610. The engagement between the contact ball bearings 606 and the detents 610 keeps the vertical support 504, and thus the PED holder 122, connected to the base 501.

In some implementations, the contact ball bearings 606 are engaged with a groove or with undercuts that extend around the interior wall of the base 501. The release slide 502 is kept in the down position, as described above, to provide an inward force 612 on each contact ball bearing 606 to keep the contact ball bearings 606 engaged with the groove or undercut. Using a groove or undercut to secure the contact ball bearings 606 may enable the vertical support 504 to rotate 618 about the central axis 505 of the vertical support 504. In some implementations, the vertical support 504 can rotate up to 360° around the central axis 505 when secured using grooves or undercuts in the base 501. In some implementations, the vertical support 504 remains stationary and does not rotate at all.

As shown in FIG. 6B, the vertical support 504 is disengaged from the base 501. To disconnect the vertical support 504, the release slide 502 is pulled upward, removing the inward force being applied to the contact ball bearings 606 and thus allowing the contact ball bearings 606 to disengage from the corresponding detents 610. Once the contact ball bearings 606 are disengaged from the detents 610, the vertical support 504 can be quickly and easily removed from the base 501.

The release slide 502 includes a first set of release slide detents 614 and a second set of release slide detents 616 that engage with the release ball bearings 608. When the release slide 502 is in the up position, the first set of release slide detents 614 engages with the release ball bearings 608 to maintain the release slide 502 in the up position. When the release slide 502 is in the down position, the second set of release slide detents 616 engage with the release ball bearings 608 to maintain the release slide 502 in the down position.

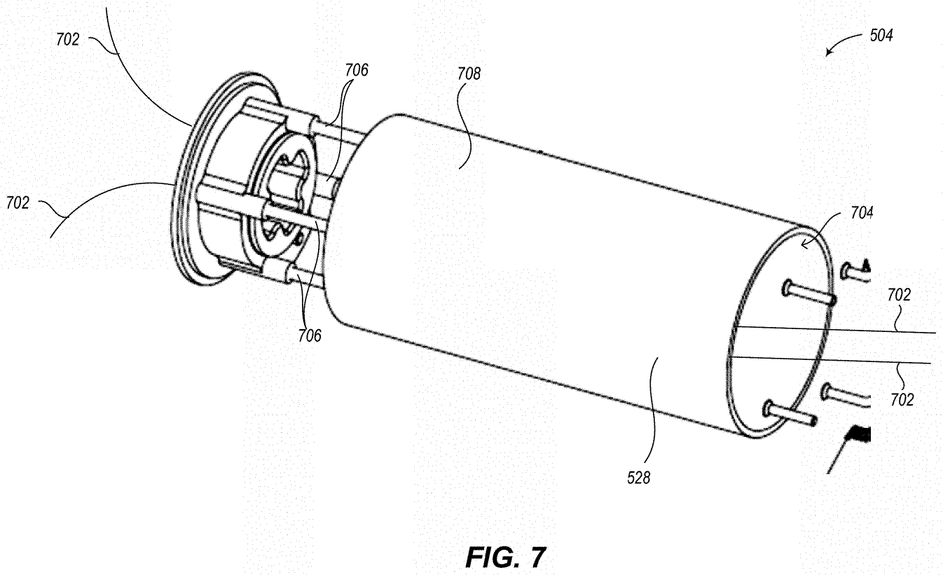

FIG. 7 is an isometric view of the interior of the vertical support 504, according to an illustrated implementation. The vertical support 504 is substantially hollow, which advantageously reduces the overall weight of the PED holder 122 and allows for one or more electrical wires 702 to be passed through the interior portion 704 of the vertical support 504. For example, the hollow interior 704 of the vertical support 504 may contain one or more electrical wires 702 that run from the one or more electrical connections in the bottom end 528 of the vertical support 504 to the PED 124. The electrical wires 702 may be used to enable the PED 124 and the video converter 120 to communicate when the PED 124 is attached to the PED holder 122. The electrical wires 702 may optionally be used to provide power to the PED 124 when it is attached to the PED holder 122. The vertical support 504 includes multiple load-bearing stringers 706 that are located in the hollow portion of the vertical support 504 and that run substantially the entire length of the vertical support 504. Any load applied at a first joint 506 to the vertical support 504 is carried substantially by the one or more stringers 706 to the base 501. In some implementations, one or more of the stringers 706 may include threaded screws that extend the length of the vertical support 504 and can be secured to corresponding threaded holder blocks located within the release slide 502. The stringers 706 may be tightened to a specified torque to provide the desired strength for the vertical support 504. The one or more stringers 706 are covered by a sleeve 708. The sleeve 708 may be comprised of a thin and light-weight material to further reduce the overall weight and size of the PED holder 122.

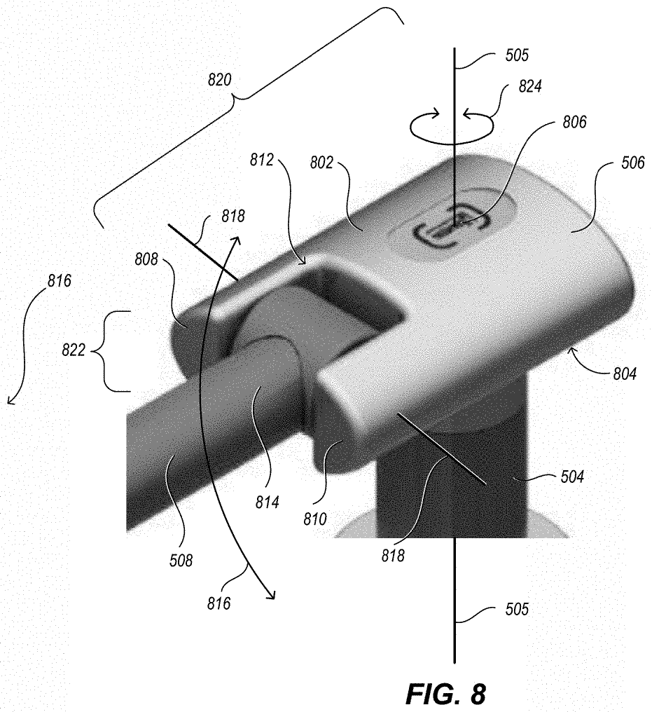

FIG. 8 is an isometric view of a portion of the PED holder 122 in which the first joint 506 attaches to the vertical support 504 and the long horizontal support 508, according to one illustrated implementation. The first joint 506 has a top portion 802 that is located opposite from the vertical support 504 and may be visible to a user. The first joint 506 has a bottom portion 804 that is opposite the top portion 802 and located nearest the vertical support 504. The interior of the first joint 506 between the top portion 802 and the bottom portion 804 may be substantially hollow, thereby reducing the overall weight of the PED holder 122, and providing a cavity through which one or more electrical wires 702 (not shown) can be run. The first joint 506 attaches to the vertical support 504 through one or more physical registration features, such as screws or bolts. The first joint 506 may be about 5 inches in length 820, and about one-half to one inch in height 822. In some implementations, the first joint 506 can rotate 824 around the central axis 505 of the vertical support 504. In such implementations, the rotation of the first joint 506 may be limited, for example, to 180° or 150° around the central axis 505 of the vertical support 504. The rotation may be limited, for example, based on the location of the PED holder 122, such as when the PED holder 122 is placed in a confined area that allows for a limited range of motion. The rotation of the first joint 506 may be limited to prevent internal electrical wiring 702 that runs from the bottom of the vertical support 504 to the PED 124 from becoming tangled. The top portion 802 of the first joint 506 may optionally include one or more electrical ports 806 (only one shown) that can be used to connect to external electronic devices (e.g., smartphone, tablet, camera, wearable computer, etc.). For example, the electrical ports 806 can include one or more types of USB connections that provide power to external devices. In addition, the electrical ports 806 can be part of a USB Hub that allows the external devices connected to the electrical port 806 to be accessed and used by a PED 124 that is connected to the PED holder 122.

The first joint 506 includes a first arm 808 and a second arm 810 that extend outwards in a direction that is perpendicular to the central axis 505 of the vertical support 504. The first arm 808 and the second arm 810 may be substantially parallel to one another and separated by a distance of about one-half to one inch. The first arm 808 and the second arm 810 may each include notches that are located opposite of and facing one another across an interior portion 812 formed by the first arm 808 and the second arm 810. The notches located in the first arm 808 and the second arm 810, as well as the interior portion 812, are sized and shaped to receive a proximate end 814 of the long horizontal support 508.

The proximate end 814 of the long horizontal support 508 may be sized and shaped to be located within the interior portion 812 formed by the first arm 808 and the second arm 810. In addition, the proximate end 814 may include one or more extensions that extend into the notch located within the first arm 808 and into the notch located in the second arm 810, thereby forming a wrist joint that enables the long horizontal member to rotate 816 about a horizontal axis 818 that extends between the center of the notch in the first arm 808 and the center of the notch in the second arm 810. The horizontal axis 818 is perpendicular to the central axis 505 of the vertical support 504. The horizontal axis 818 is also perpendicular to a central axis that runs in the center of the long horizontal support 508 from its proximate end 814 to its distal end 816. Accordingly, the wrist joint enables the long horizontal support 508 to rotate 180° around the horizontal axis 818 from a fully retracted position, in which a distal end 816 of the long horizontal support 508 is rotated towards the vertical support 504, to a fully extended position, in which the distal end 816 of the long horizontal support 508 is rotated away from the vertical support 504. In both the fully retracted position and the fully extended position, the central axis of the long horizontal support 508 is parallel to the central axis 505 of the vertical support 504. When the long horizontal support 508 is at an angle of 90°, as shown in FIG. 5, the central axis of the long horizontal support 508 is perpendicular to the central axis 505 of the vertical support 504.

In some implementations, the proximate end 814 of the long horizontal support 508 may include one or more registration features that allow the long horizontal support 508 to support a PED 124 at multiple angles between the fully retracted position at 0° and the fully extended position at 180°. For example, the one or more registration features may enable a user to change the angle at which the long horizontal support 508 will support a PED 124 in increments of 5°, 10°, 15°, etc. between the fully retracted state and the fully extended state. In some implementations, one or more electrical wires 702 (not shown) travel from the first joint 506 to the long horizontal support 508 through an opening in the proximate end 814 of the long horizontal support 508. These electrical wires 702 provide a connection from the vertical support 504 to a PED 124 attached to the PED holder 122. The electrical wires 702 may also be used to provide power to the PED 124 when it is attached to the PED holder 122.

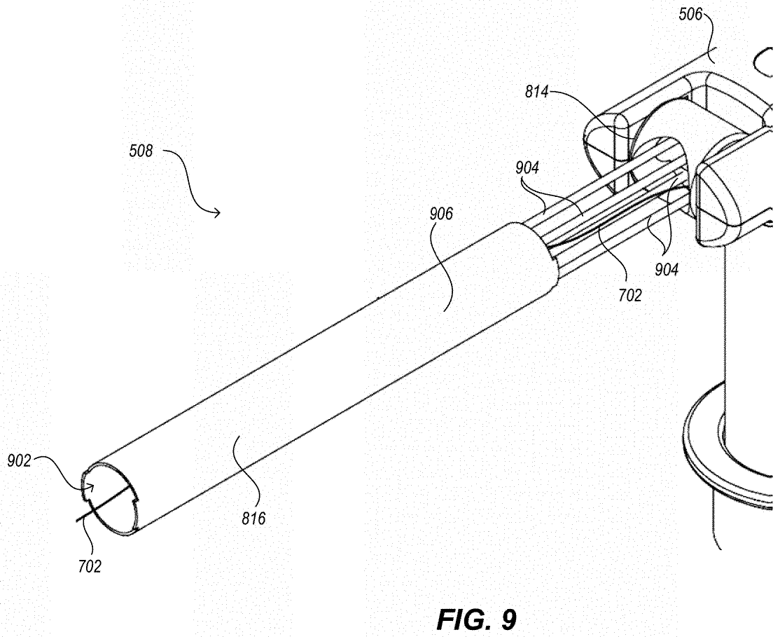

FIG. 9 is an isometric view of the interior portions of the long horizontal support 508, according to one illustrated implementation. The long horizontal support 508 is substantially cylindrical in shape and includes the proximate end 814 attached to the first joint 506, as discussed above, and a distal end 816 attached to the second joint 510. The long horizontal support 508 is substantially hollow, which advantageously reduces the overall weight of the PED holder 122 and allows for one or more electrical wires 702 to traverse the interior portion 902 of the long horizontal support 508. For example, the hollow interior 902 of the long horizontal support 508 may contain one or more electrical wires 702 that run from the one or more electrical connections in the bottom end 528 of the vertical support 504 to the PED 124. The electrical wires 702 enable the PED 124 and the video converter 120 to communicate when the PED 124 is attached to the PED holder 122. Optionally, the electrical wires 702 may provide power to the PED 124 when it is attached to the PED holder 122. The long horizontal support 508 includes one or more load-bearing stringers 904 that are located in the hollow portion 902 of the long horizontal support 508 and that run substantially the entire length of the long horizontal support 508. Any load applied at the second joint 510 to the long horizontal support 508 is carried substantially by the one or more stringers 904 to the first joint 506. In some implementations, one or more of the stringers 904 may include threaded screws that extend the length of long horizontal support 508 and are secured to corresponding threaded holder blocks within the proximate end 814 of the long horizontal support 508 or within the second joint 510. The stringers 904 may be tightened to a specified torque to provide the desired strength for the long horizontal support 508. The one or more stringers 904 are covered by a sleeve 906. The sleeve 906 may be comprised of a thin and light-weight material to further reduce the overall weight and size of the PED holder 122.

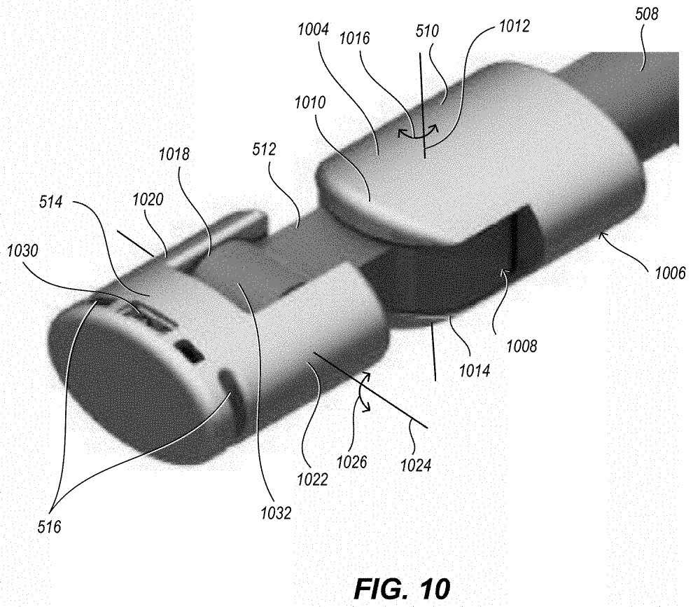

FIG. 10 is an isometric view of a portion of the PED holder 122 that shows the distal end 816 of the long horizontal support 508, the second joint 510, the short horizontal support 512, and the third joint 514, according to one illustrated implementation. The proximate end 1002 of the second joint 510 is connected to the distal end 816 of the long horizontal support 508. The second joint 510 has a top portion 1004 and a bottom portion 1006 that is located opposite the top portion 1004. The second joint 510 may be substantially hollow inside, creating a space for electrical wires to traverse the entire length of the second joint 510 from the long horizontal support 508 to the short horizontal support 512. The top portion 1004 and the bottom portion 1006 of the second joint 510 form a recess 1008 that is located at a distal end 1010 of the second joint 510. The recess 1008 includes one or more registration features that are used to attach to a proximate end 1014 of the short horizontal support 512 and to provide the short horizontal support 512 with a vertical axis of rotation 1012 that is perpendicular to the central axis of the long horizontal support 508. The registration feature within the second joint 510 enables the short horizontal support 512 to rotate 1016 about the axis of rotation 1012. In some implementations, the short horizontal support 512 can rotate up to 270° around the axis of rotation 1012.

A distal end 1018 of the short horizontal support 512 connects to the third joint 514. The third joint 514 has a first arm 1020 and a second arm 1022 on opposing sides of the third joint 514. The first arm 1020 and the second arm 1022 are substantially parallel to each other, and form a cavity 1032 that receives and connects to the distal end 1018 of the short horizontal support 512. In some implementations, the first arm 1020 may have a notch or recess on a side that faces the interior cavity 1032. The second arm 1022 may have a corresponding notch or recess located on a side that faces the interior cavity 1032 and that opposes the notch or recess on the first arm 1020. The distal end 1018 of the short horizontal support may have extensions that extend out towards and engage with the notches or recesses in each of the first arm 1020 and the second arm 1022 of the third joint 514, thereby securing the third joint 514 to the short horizontal support 512. The notches or recesses form an axis of rotation 1024 around which the third joint 514 rotates 1026. The axis of rotation 1024 is perpendicular to a central axis 1028 of the short horizontal support 512 that runs from the proximate end 1014 to the distal end 1018 of the short horizontal support 512. In some implementations, the third joint 514 rotates 1026 up to 180° or more around the axis of rotation 1024. The connection between the short horizontal support 512 and the third joint 514 may include one or more registration features that allow the third joint 514 to support a PED 124 at multiple angles between the minimum angle and maximum angle at which the third joint 514 can rotate (e.g., 0° and) 180°. For example, the one or more registration features may enable a user to change the angle at which the third joint 514 supports a PED 124 in increments of 5°, 10°, 15°, etc., between the minimum and maximum angles that the third joint 514 rotates.

The third joint 514 includes one or more electrical ports 1030 to which the PED 1024 connects. The electrical ports 1030 connect to the electrical connectors in the bottom of the vertical support 504 using the electrical wires 702. The electrical ports 1030 may be one or more types of USB connectors that can be used to provide digital or multimedia content to the PED 124. The third joint 514 may optionally include QuickCharge capabilities, such as provided by Qualcomm Inc., to enable the PED holder 122 to more quickly charge a PED 124 that is connected to the electrical ports 1030. In addition, the electrical ports 1030 may provide smart USB charging capabilities that enable PEDs 124 or other connected devices to draw up to 100 Watts of energy for operation and charging. In addition, the electrical ports 1030 may be part of a USB hub network that allows a PED 124 to connect to multiple external devices connected to other USB ports, such as port 806 (FIG. 8). In some implementations, the PED holder 122 may include a near field communication (NFC) tag that provides a signal to an app on the PED 124 to notify the user when the PED 124 is attached to the PED holder 122 but is not connected to any of the electrical ports 1030 provided on the third joint 514. In some implementations, the PED holder 122 includes a wireless charging pad to allow the PED holder 122 to wirelessly charge a PED 124 connected to the PED holder 122.

The third joint 514 includes one or more registration features 516 to engage and support the PED 124. As shown in FIG. 10, the registration features may include one or more grooves 516 that are used to secure the PED 124 to the PED holder 122. In such implementations, the PED 124 is encompassed within a sleeve or holder that has corresponding and complementary registration features, such as ridges that slide into and attach to the grooves 516. The sleeve or holder may optionally include a connector that is positioned to engage with one or more of the electrical ports 1030 when the registration features on the sleeve are secured by the complementary registration features on the third joint 514. This connector may also be connected to a port on the PED 124 to provide a data or power connection. Other types of registration features, such as connectors, clamps, or magnets may be used to secure the PED 124 to the third joint 514.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various implementations described above can be combined to provide further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method for connecting to a personal electronic device (PED) running a first operating system, the method comprising:
detecting, by a processor, that the PED has been attached to a PED holder;
detecting, by the processor, the first operating system running on the PED;
initiating, by the processor, a handshake protocol with the PED;
pausing, by the processor, to allow the PED to reconnect in an accessory mode; and
transmitting, by the processor, a data stream upon receiving a start stream command from the PED.

2. The method of claim 1 wherein detecting the first operating system further includes receiving vender identification data and product identification data from the PED.

3. The method of claim 1 wherein detecting the first operating system includes detecting the operating system and determining compatibility of the PED.

4. The method of claim 1, further comprising:
operating in a host mode when detecting that the PED has been connected to the PED holder.

5. The method of claim 1 wherein the start stream command is transmitted automatically by the PED when the PED is attached to the PED holder.

6. A method for connecting to a personal electronic device (PED) running a first operating system, the method comprising:
detecting, by a processor, that the PED has been attached to a PED holder;
detecting, by the processor, the first operating system running on the PED;
initiating, by the processor, a handshake protocol with the PED;
receiving, by the processor, an identification from the PED of a port for transmitting data;
pausing, by the processor, to allow the PED to reconnect in an accessory mode; and
transmitting, by the processor, a data stream to the port upon receiving a start stream command from the PED.

7. The method of claim 6 wherein detecting the first operating system further includes receiving vender identification data and product identification data from the PED.

8. The method of claim 6, further comprising:
operating in a host mode when detecting that the PED has been connected to the PED holder.

9. The method of claim 6 wherein the start stream command is transmitted automatically by the PED when the PED is attached to the PED holder.
